(19) United States
(12) Patent Application Publication
(10) Pub. No.: US 2024/0221122 A1
(43) Pub. Date: Jul. 4, 2024

(54) IMAGE SPLICING METHOD AND ELECTRONIC DEVICE

(71) Applicant: BEIJING DAJIA INTERNET INFORMATION TECHNOLOGY CO., LTD., Beijing (CN)

(72) Inventor: Zihui YE, Beijing (CN)

(21) Appl. No.: 18/398,719

(22) Filed: Dec. 28, 2023

(30) Foreign Application Priority Data
Jan. 3, 2023 (CN) 202310015401.3

(51) Int. Cl. G06T 5/50; G06F 3/04845; G06F 3/0486; G06F 3/0488

(52) U.S. Cl. CPC G06T 5/50; G06F 3/04845; G06F 3/0486; G06F 3/0488; G06T 2207/20221

(57) ABSTRACT

Provided is an image splicing method, belonging to the technical field of image processing. The method includes: displaying an image splicing interface, wherein the image splicing interface includes a spliced-image previewing region, an image selecting region, and a template selecting region; determining an image to be spliced in response to a select operation on at least one image in the image selecting region; determining, based on a number of the images to be spliced, a first splicing template matching the number of images to be spliced, and displaying a first spliced image in the spliced-image previewing region based on the images to be spliced and the first splicing template.

This application is based upon and claims priority to Chinese Patent Application No. 202310015401.3, filed on Jan. 3, 2023, the disclosure of which is herein incorporated by reference in its entirety.

### TECHNICAL FIELD

The present disclosure relates to the technical field of image processing, and in particular, relates to an image splicing method and an electronic device.

### BACKGROUND

With the development of Internet technologies, an increased number of users are posting images on the Internet. Before posting a large number of images, the user often splices the images, and then posts the spliced image. In the related art, the user first selects images to be spliced in an image selecting interface, then selects a splicing template in an image splicing interface, and acquires a spliced image by applying the splicing template to the images to be spliced.

### SUMMARY

Embodiments of the present disclosure provide an image splicing method and an electronic device, which reduce the operation cost of image splicing and improves the efficiency of image splicing.

According to one aspect of the embodiments of the present disclosure, an image splicing method is provided.

The method includes: displaying an image splicing interface, the image splicing interface including a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates including at least one splicing template; determining an image to be spliced in response to a select operation on at least one of the images in the image selecting region; and displaying a first spliced image in the spliced-image previewing region based on the image to be spliced and a first splicing template, wherein the first splicing template is a splicing template, matching a first number, in the plurality of groups of splicing templates, the first number being a number of the images to be spliced.

According to another aspect of the embodiments of the present disclosure, an electric device is provided.

The electric device includes: one or more processors; and a memory, configured to store one or more program codes executable by the one or more processors; wherein the one or more processors, when loading and executing the one or more program codes, are caused to perform: displaying an image splicing interface, the image splicing interface including a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates including at least one splicing template; determining an image to be spliced in response to a select operation on at least one of the images in the image selecting region; and displaying a first spliced image in the spliced-image previewing region based on the image to be spliced and a first splicing template, wherein the first splicing template is a splicing template, matching a first number, in the plurality of groups of splicing templates, the first number being a number of the images to be spliced.

According to another aspect of the embodiments of the present disclosure, a non-transitory computer-readable storage medium storing one or more program codes is provided. The one or more program codes, when loaded and executed by a processor of an electronic device, cause the electronic device to perform: displaying an image splicing interface, the image splicing interface including a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates including at least one splicing template; determining an image to be spliced in response to a select operation on at least one of the images in the image selecting region; and displaying a first spliced image in the spliced-image previewing region based on the image to be spliced and a first splicing template, wherein the first splicing template is a splicing template, matching a first number, in the plurality of groups of splicing templates, the first number being a number of the images to be spliced.

### BRIEF DESCRIPTION OF DRAWINGS

FIG. 1 is a schematic diagram of an implementation environment of an image splicing method according to some embodiments of the present disclosure;

FIG. 2 is a flowchart of an image splicing method according to some embodiments of the present disclosure;

FIG. 3 is a flowchart of an image splicing method according to some embodiments of the present disclosure;

FIG. 4 is a schematic diagram of an image selecting interface according to some embodiments of the present disclosure;

FIG. 5 is a schematic diagram of an image editing interface according to some embodiments of the present disclosure;

FIG. 6 is a schematic diagram of an image splicing interface according to some embodiments of the present disclosure;

FIG. 7 is a schematic diagram of an image editing interface according to some embodiments of the present disclosure;

FIG. 8 is a schematic diagram of a work posting interface according to some embodiments of the present disclosure;

FIG. 9 is a schematic diagram of a posting history interface according to some embodiments of the present disclosure;

FIG. 10 is a schematic diagram of a work playback interface according to some embodiments of the present disclosure;

FIG. 11 is a structural block diagram of an image splicing apparatus according to some embodiments of the present disclosure; and

FIG. 12 is a structural block diagram of a terminal according to some embodiments of the present disclosure.

### DETAILED DESCRIPTION

It should be noted that the information (including, but not limited to, user device information and user personal information) and data (including, but not limited to, data for analysis, data for storage, and data for display) involved in the present application are information and data that have been authorized by the user or have been fully authorized by the parties. The collection, use, and processing of the relevant data need to comply with the relevant laws, regulations, and standards of the relevant countries and regions. For example, the images and the like in the target storage space involved in this application are acquired under full authorization.

The implementation environment of the embodiments of the present disclosure is described hereinafter.

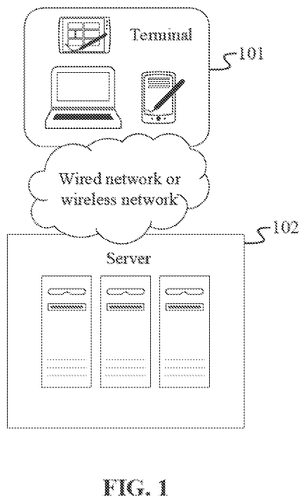

FIG. 1 is a schematic diagram of an implementation environment of an image splicing method according to some embodiments of the present disclosure. As illustrated in FIG. 1, the implementation environment involves a terminal 101 and a server 102. The terminal 101 is connected to the server 102 over a wireless network or a wired network.

The terminal 101 is at least one of electronic devices such as a smartphone, a smartwatch, a desktop computer, a laptop computer, a virtual reality terminal, an augmented reality terminal, a wireless terminal, and the like. The terminal 101 has a communication function and is capable of accessing the Internet via wired network or wireless network. The terminal 101 refers generically to one of a plurality of terminals, and the embodiments of the present disclosure are described only using the terminal 101 as an example. It should be noted by those skilled in the art that in some embodiments, the number of terminals is not limited. Schematically, an application runs on the terminal 101, which provides an image splicing function. A user logged in to the application is able to splice multiple images in a target storage space by the application to acquire a spliced image, and then perform operations on the spliced image, such as saving the spliced image, editing the spliced image, posting the spliced image, or setting the spliced image as a video cover. The application may be a short video application, a social application, a conference application, or an image processing application, which is not limited herein.

The server 102 is a stand-alone physical server, a server cluster or distributed file system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), big data, and Artificial Intelligence (AI) platforms. The server 102 is configured to provide background services for the applications running on the terminal 101. For example, the server 102 provides user account login and image posting services for the applications running on the terminal 101.

In some embodiments, the wired network or wireless network uses standard communication technologies and/or protocols. The network is typically the Internet but can be any network including, but not limited to, a local area network (LAN), a metropolitan area network (MAN), a wide area network (WAN), a mobile, wired, or wireless network, a private network, or a virtual private network and any combinations thereof. In some embodiments, technologies and/or formats including hypertext markup language (HTML), extensible markup language (XML), and the like are used to represent data exchanged over the network. It is also possible to use conventional encryption technologies such as Secure Socket Layer (SSL), Transport Layer Security (TLS), virtual private network (VPN), and Internet Protocol Security (IPsec) to encrypt all or some of the links. In other embodiments, it is also possible to use customized and/or specialized data communication technologies to instead or supplement the data communication technologies described above.

In the related art, a user first selects images to be spliced in an image selecting interface, then selects a splicing template in an image splicing interface, and acquires a spliced image by applying the splicing template to the images to be spliced. If the user needs to change the number of images to be sliced, the user needs to go back to the image selecting interface to perform the image selection, which is not flexible and affect the efficiency of the image slicing.

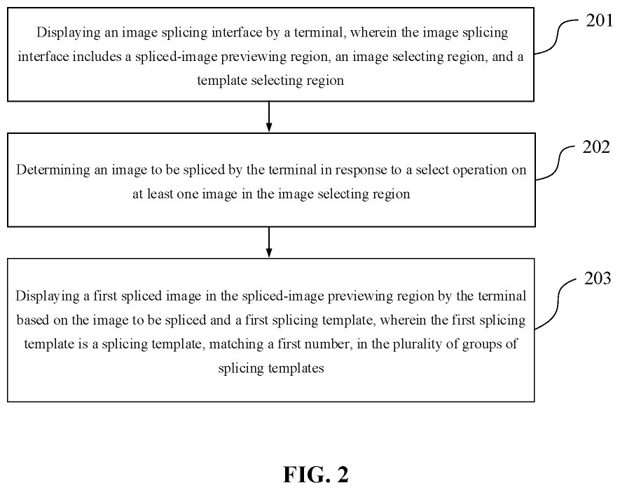

The implementation environment of the image splicing method according to some embodiments of the present disclosure has been described above. A flow of the image splicing method according to some embodiments of the present disclosure is described hereinafter. FIG. 2 is a flowchart of an image splicing method according to some embodiments of the present disclosure. As illustrated in FIG. 2, the method is performed by the terminal such as an electronic device described above, and the method includes the steps 201 to 203.

In step 201, the terminal displays an image splicing interface, wherein the image splicing interface includes a spliced-image previewing region, an image selecting region, and a template selecting region.

The spliced-image previewing region is configured to allow previewing a spliced image. The image selecting region is configured to display a plurality of images in a target storage space. The target storage space refers to a user-authorized local storage space, that is, a storage space of the terminal. In some embodiments, the target storage space refers to a user-authorized cloud storage space. The target storage space includes a plurality of images selected by the user and additional images in the local storage space for the user's selection. The template selecting region is configured to display a plurality of groups of splicing templates. Each group of splicing templates corresponds to a different number of images, and each group of splicing templates includes at least one splicing template. For example, the template selecting region may display four groups of splicing templates. Each group of splicing templates is configured to splice a fixed number of images, and each group of splicing templates respectively corresponds to two images, three images, four images, and five images. Each group of splicing templates includes five splicing templates. These five splicing templates splice the same number of images, but these five splicing templates provide different typographic layouts. Each of the splicing templates includes at least one position box indicating a position on the spliced-image of each image to be spliced based on this splicing template. The number of position boxes included in the splicing template is equal to the number of images to be spliced corresponding to this splicing template. For example, if the number of the images are five. The five images may be arranged in a layout of having two images in the left and three images in the right (e.g., two boxes in the left and three boxes in the right) or in a layout of have two images on the top and three images on the bottom (e.g., two boxes on the top and three boxes on the bottom).

The terminal displays the image splicing interface in response to a splicing function of a target application being triggered. The target application is an application running on the terminal, and the target application provides the splicing function. The target application may be a short video application, a social application, a conference application, or an image processing application, which is not limited herein. The splicing function refers to a function of splicing images.

Because different applications have different settings, the target application displays the image splicing interface in two different manners.

In a first manner, the process that the terminal displays the image splicing interface in response to the splicing function of the target application being triggered includes: displaying an image selecting interface, which is configured to display the plurality of images in the target storage space; displaying an image editing interface in response to a select operation on at least one image in the image selecting interface; and displaying the image splicing interface in response to a tap operation on a splicing function control in the image editing interface.

In a second manner, the process that the terminal displays the image splicing interface in response to the splicing function of the target application being triggered includes: displaying an application function interface, which includes a splicing function control; displaying an image selecting interface in response to a tap operation on the splicing function control; and displaying the image splicing interface in response to a select operation on at least one image in the image selecting interface.

It should be noted that the above two manners are only exemplary, and the target application may also display the image splicing interface in other manners depending on the actual settings of the application, which is not limited herein.

In step 202, the terminal determines an image to be spliced in response to a select operation on at least one image in the image selecting region.

The image to be spliced includes at least one image acquired based on a select operation on an image in the image selecting interface and a select operation on an image in the image selecting region.

In step 203, the terminal displays a first spliced image in the spliced-image previewing region based on the image to be spliced and a first splicing template, wherein the first splicing template is a splicing template that matches a first number in the plurality of groups of splicing templates, and the first number is the number of images to be spliced.

The first number is the number of images selected in the image selecting interface and the number of images selected in the image selecting region. The first spliced image is a spliced image acquired by splicing the images to be spliced.

In some embodiments, the process that the terminal displays the first spliced image in the spliced-image previewing region based on the first splicing template according to selection sequence numbers of the images to be spliced includes: acquiring the selection sequence numbers of the images to be spliced; determining, based on the selection sequence numbers of the images to be spliced, images corresponding to various position boxes in the first splicing template; and acquiring the first spliced image by arranging the images to be spliced on positions corresponding to the position boxes. In some embodiments, the terminal randomly arranges the images to be spliced on the positions corresponding to the position boxes, which is not limited herein.

According to the above method, the image splicing interface provides a image selectin region such that the images can be selected from the image selecting region in the image splicing interface, and the user does not need to perform operations such as jumping back and forth in the case that the number of images to be spliced needs to be changed, which flexibly adapts to the demand of splicing different numbers of images, such that the operating cost is reduced, and the efficiency in splicing images is improved.

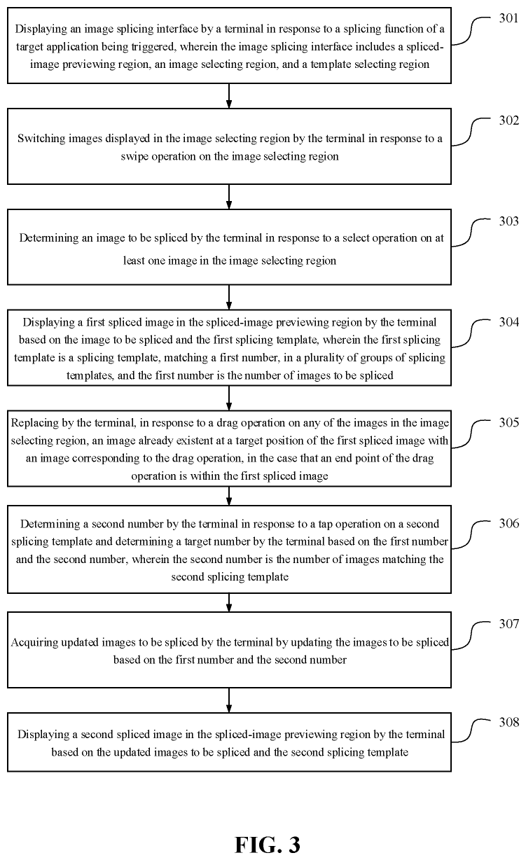

FIG. 2 illustrates only the basic flow of the present disclosure, and the technical solution of the present disclosure is further elaborated hereinafter. FIG. 3 is a flowchart of an image splicing method according to some embodiments of the present disclosure. As illustrated in FIG. 3, the method is performed by the terminal described above and includes steps 301 to 308.

In step 301, the terminal displays an image splicing interface in response to a splicing function of a target application being triggered, wherein the image splicing interface includes a spliced-image previewing region, an image selecting region, and a template selecting region.

In some embodiments, the terminal displays a plurality of images in a target storage space in the image selecting region based on an arrangement of the images in the target storage space. For example, in the case that the images are arranged in the target storage space according to their dates, a plurality of images recently taken or saved are displayed in the image selecting region. In some embodiments, the terminal displays, based on a select operation on images in an image selecting interface and according to a sequence of the images in the target storage space, a plurality of images adjacent to the selected images in the image selecting region. In some embodiments, the images displayed in the image selecting region are arranged in rows or columns. A plurality of rows or columns of images are displayed in the image selecting region without affecting the vision. The splicing templates in the template selecting region are arranged in the same manner as the images in the image selecting region, which is not repeated herein.

It should be noted that the above description of the images displayed in the image selecting region, the arrangement of the images in the image selecting region, and the arrangement of the splicing templates in the template selecting region are only exemplary, which are not limited herein.

In some embodiments, positions of the spliced-image previewing region, the image selecting region, and the template selecting region in the image splicing interface are set according to an operating habit of the terminal user. For example, in the case that the terminal detects that the user is accustomed to operating with his or her right hand, the spliced-image previewing region is set in a left part of the image splicing interface, and the image selecting region and the template selecting region are set in a right part of the image splicing interface, which is convenient for the user to select images and templates while allowing conveniently previewing the spliced image. As another example, the user adjusts the positions of the spliced-image previewing region, the image selecting region, and the template selecting region in the image splicing interface by performing a swipe operation on each of the regions. As yet another example, the image splicing interface includes a display control. In the case that the image selecting region is displayed in the image splicing interface, the image selecting region is hidden in response to a trigger operation on the display control. In the case that the image selecting region is not displayed in the image splicing interface, the image selecting region is displayed in response to a trigger operation on the display control. In some embodiments, the image selecting region is a page floated on the image splicing interface. The positional relation between the regions in the image splicing interface is not limited herein.

In some embodiments, the terminal, when displaying the image splicing interface, displays, based on the images selected in the image selecting interface, a spliced image of the selected images in the spliced-image previewing region of the image splicing interface.

In step 302, the terminal switches images displayed in the image selecting region in response to a swipe operation on the image selecting region.

The swipe operation on the image selecting region corresponds to the arrangement of the images in the image selecting region. For example, the images in the image selecting region are arranged in rows, and accordingly, the swipe operation on the image selecting region is a left-right swipe; or the images in the image selecting region are arranged in columns, and accordingly, the swipe operation on the image selecting region is an up-down swipe. The terminal, in response to the swipe operation on the image selecting region, switches the images displayed in the image selecting region based on a display sequence of the images in the image selecting region.

By step 302, the user browses the images in the target storage space by the swipe operation on the image selecting region, and thus is able to select the images without jumping out of the image splicing interface. In this way, the user's operation cost is reduced, and the efficiency in splicing images is improved.

In step 303, the terminal determines an image to be spliced in response to a select operation on at least one image in the image selecting region.

For details about step 303, reference is made to step 202, which are not repeated herein.

In step 304, the terminal displays a first spliced image in the spliced-image previewing region based on the image to be spliced and the first splicing template, wherein the first splicing template is a splicing template matching a first number in a plurality of groups of splicing templates.

The process of determining the first splicing template by the terminal includes: determining the first number, wherein the first number is the number of images to be spliced; determining, based on the first number, a group of splicing templates corresponding to the first number; and determining the first splicing template that matches the first number from the group of splicing templates.

The terminal determining the first splicing template that matches the first number from the group of splicing templates includes the following two cases.

In the case that each group of splicing templates includes only one splicing template, the first splicing template is a splicing template corresponding to the first number. In the above method, there is only one splicing template in each group of splicing templates. That is, there is only one splicing template matching the number of images to be spliced. In the case that the number of images to be spliced remains unchanged, the user does not need to determine an optimal splicing template by selecting the splicing templates several times, which reduces the user's operation cost. In addition, because a certain of images to be spliced corresponds to only one splicing template, it is favorable to reduce the development cost.

In the case that each group of splicing templates includes a plurality of splicing templates, the terminal determines a third splicing template in each group of splicing templates according to a history splicing process of the user, wherein the third splicing template in each group of splicing templates is a splicing template whose use frequency by the user is ranked at a top place in this group of splicing templates, and determines a splicing template that matches the first number in the third splicing templates as the first splicing template. In some embodiments, the terminal determines a fourth splicing template in each group of splicing templates based on the usage of the splicing templates by all users, wherein the fourth splicing template in each group of splicing templates is a splicing template whose number of users is ranked at a top place in this group of splicing templates, and determines a splicing template that matches the first number in the fourth splicing templates as the first splicing template, which is not limited herein. In the above method, a splicing template that is more frequently used by the user in the plurality of splicing templates corresponding to the first number is determined as a default splicing template, such that the splicing template determined by the terminal is more in line with the user's splicing preference, and in the case that the number of images to be spliced remains unchanged, the select operations by the user on the splicing templates are effectively reduced, and thus the efficiency in splicing images is improved.

Steps 301 to 304 describe the process of acquiring the spliced image by splicing the selected images. Further, in some embodiments, the user replaces the selected image by a drag operation on any of the images in the image selecting region. The process includes step 305.

In step 305, the terminal, in response to a drag operation on any of the images in the image selecting region, replaces an image already existent at a target position of the first spliced image with an image corresponding to the drag operation, in the case that an end point of the drag operation is within the first spliced image.

The terminal determines whether the end point of the drag operation is within the first spliced image by detecting the end point of the drag operation. The target position is any position of the first spliced image displayed in the spliced-image previewing region.

By step 305, the replacement of the image in the first spliced image is achieved by the drag operation, and the user does not need to manually deselect the image and then manually select a new image for replacement by tapping, which makes the operation more flexible and reduces the user's operation cost.

Steps 301 to 304 indicate the process in which the terminal automatically determines the first splicing template based on the number of images to be spliced and splices the images based on the first splicing template. In some embodiments, the user is able to select the splicing template by himself, and the terminal splices the images based on the splicing template selected by the user. Upon steps 301 to 305, the method further includes the steps 306 to 308.

In step 306, the terminal determines a second number in response to a tap operation on a second splicing template and determines a target number based on the first number and the second number, wherein the second number is the number of images matching the second splicing template.

The second splicing template is any template of each group of splicing templates. The first number includes the number of images selected in the image selecting interface and the number of images selected in the image selecting region. The target number is a difference between the first number and the second number, i.e., a difference between the number of images to be spliced and the number of images matching the second splicing template.

In step 307, the terminal acquires updated images to be spliced by updating the images to be spliced based on the first number and the second number.

It should be understood that in some embodiments, the number of images matching the second splicing template is not equal to the number of images to be spliced, and the terminal needs the second number of images for displaying the spliced image in the spliced-image previewing region based on the second splicing template. In the case that the user selects any template of the plurality of groups of splicing templates, the terminal updates the images to be spliced based on the first number and the second number, such that the updated number of images to be spliced is consistent with the second number.

In the case that the first number is greater than or equal to the second number, the number of images that are spliced based on the second splicing template is less than or equal to the number of images to be spliced. In this case, the terminal performs the image splicing based on the second splicing template by deleting the target number of images from the images to be spliced. In the case that the first number is less than the second number, the number of images required for the image splicing based on the second splicing template is greater than the number of images to be spliced. In this case, the terminal performs the image splicing based on the second splicing template by adding the target number of images from the target storage space to the images to be spliced. The process of updating the images to be spliced by the terminal in the above two cases is described hereinafter.

In a first case, in the case that the first number is greater than or equal to the second number, the terminal acquires the updated images to be spliced by determining the target number of first images from the images to be spliced and deleting the target number of first images from the images to be spliced.

In some embodiments, the process that the terminal determines the target number of first images from the images to be spliced includes: determining, based on selection sequence numbers corresponding to the images to be spliced, top n first images as the target number of first images, n being equal to the target number. “Top” images refers to the images that appear early in the selection sequence. For example, the images to be spliced include an image A, an image B, an image C, an image D, and an image E, the first number is 5, and the selection sequence numbers corresponding to these five images are “1,” “2,” “3,” “4,” and “5.” The number of images matching the second splicing template is 3. That is, the second number is 3, and thus the target number is 2. The terminal determines, based on the selection sequence numbers of the images to be spliced, images whose selection sequence numbers are ranked in top 2 or the first two images (the two images in the first and second positions) in the selection sequence. That is, the image A and the image B are determined as the first images. The terminal deletes the image A and the image B from the images to be spliced and acquires the image C, the image D, and the image E. The image C, the image D, and the image E are the updated images to be spliced. In the above method, the target number of images that appear early in the selection sequence are determined as the first images. Typically, the user prefers to splice the images that appear late in the selection sequence numbers, therefore, after the images whose selection sequence numbers are ranked higher are deleted from the images to be spliced, the user is less likely to re-select the deleted images, such that the efficiency of updating the images to be spliced is improved.

In a second case, in the case that the first number is less than the second number, the terminal acquires the updated images to be spliced by determining the target number of second images from the target storage space and adding the target number of second images to the images to be spliced.

The process that the terminal determines the target number of second images from the target storage space includes at least one of the following three manners.

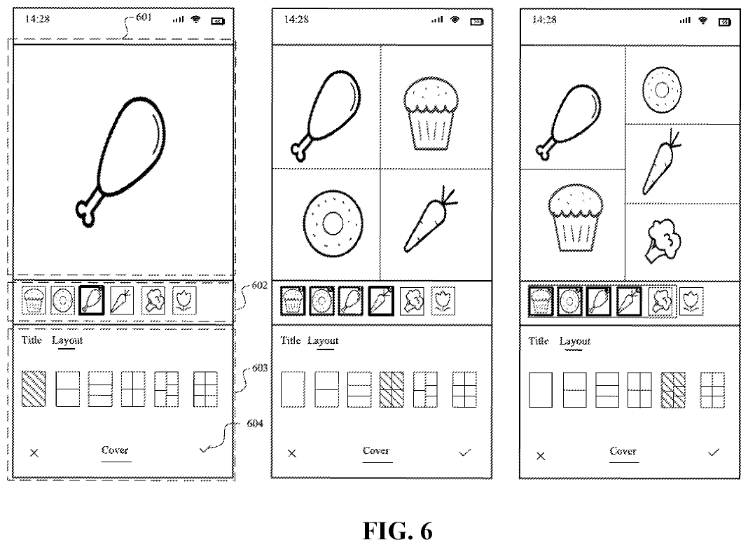

In a first manner, based on a sequence of the images to be spliced in the target storage space, the target number of images adjacent to the images to be spliced are determined as the second images. For example, in the case that the target number is 1 and the sequence of the images to be spliced in the storage space are “6^{th},” “7^{th},” and “8^{th},” the second image is an image in the target storage space whose order is “9^{th}.” FIG. 6 described below provides an example of determining the target number using the first manner. In the above method, by adding the image adjacent to the images to be spliced to the image to be spliced, the second image is quickly determined from the target storage space without consuming too many computational resources.

In a second manner, the target number of second images are determined from the target storage space based on an image attribute condition, wherein the image attribute condition refers to the second images having a target image attribute.

The image in the target storage space corresponds to an attribute field that is used to carry an image attribute of this image, and the terminal acquires the image attribute of the image by reading the attribute field of the image.

In some embodiments, the target image attribute is determined based on image attributes of the images to be spliced. The process of determining the target image attribute includes: acquiring the image attribute of each of the images to be spliced; and determining an image attribute that corresponds to a greater number of images in the images to be sliced as the target image attribute. For example, three of the five images to be spliced have an image attribute of “food,” one has an image attribute of “scenery,” and one has an image attribute of “people.” In this case, the image attribute of “food” corresponds to a greater number of images, and thus the image attribute of “food” is determined as the target image attribute. In the above embodiments, by analyzing the image attributes of the images to be spliced, it is possible to know which type of image attribute the user has a demand for splicing, such that the newly added images match the user's splicing preference, and thus manual filtering operations of the user on the newly added images are reduced, and the efficiency in splicing images is improved.

In a third manner, the target number of second images are determined from the target storage space based on an image date condition, wherein the image date condition refers to image dates of the second images being within a target period.

The image date is a date on which the image is taken, or a date on which the image is saved. In some embodiments, the target period is a history period using a current system time as a cutoff point. That is, a recently saved image is determined as the second image. In some embodiments, the target period is a period between an occurrence time of the last image splice operation and the current system time. Accordingly, the process that the terminal determines the target number of second images from the target storage space includes: acquiring the occurrence time of the last image splice operation; and based on the occurrence time and an image date of each image to be spliced, filtering the target number of second images, whose image dates are located after the occurrence time, from the target storage space. Because the second images filtered based on the above method do not include images that have already been spliced, the user does not need to manually filter the added images. In this way, the user's operation cost is reduced, the effectiveness of updating the images to be spliced is improved, and the efficiency in splicing images is improved.

It should be noted that the above three manners of determining the second images are only exemplary, and in some embodiments, the second images may also be determined in other ways, such as based on image quality conditions, which is not limited herein.

In step 308, the terminal displays a second spliced image in the spliced-image previewing region based on the updated images to be spliced and the second splicing template.

For details about step 308, reference is made to step 304, which are not repeated herein.

In some embodiments, the user performs the drag operation on any image in the image selecting region, and in the case that the end point of the drag operation is within the second spliced image, the terminal replaces an image already existent at a target position of the second spliced image with an image corresponding to the drag operation, which is the same as step 305 and is not repeated herein.

By steps 306 to 308, the images to be spliced are automatically updated based on the splicing template selected by the user, and the spliced image is displayed in the spliced-image previewing region based on the updated images to be spliced. In this way, the select operations of the user on the images are reduced, and the efficiency in splicing images is improved.

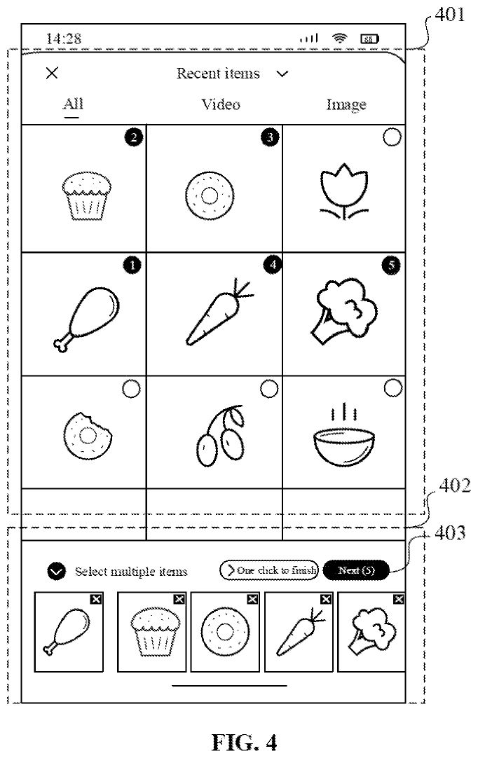

In some embodiments, the image splicing method described above is applicable to a short video application to achieve the use of a spliced image of multiple images as a cover of a work to be posted. An operation flow of a short video application to acquire a cover of a work based on the image splicing method described above is described hereinafter based on FIG. 4 to FIG. 6.

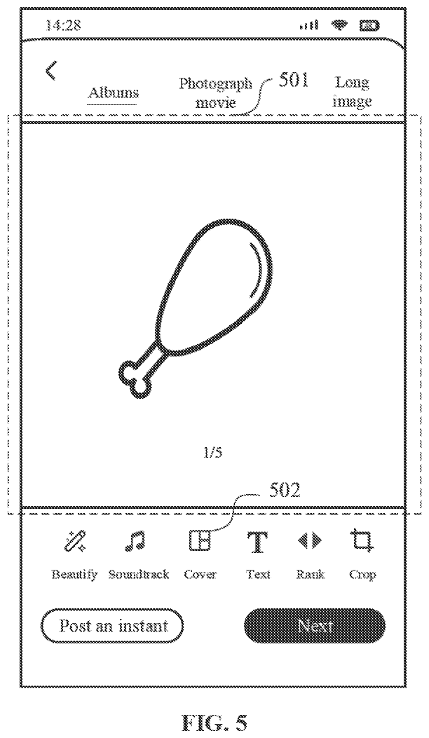

An operation flow of the terminal displaying an image splicing interface in response to a splicing function of a short video application being triggered is described first. As illustrated in FIG. 4, which is a schematic diagram of an image selecting interface according to some embodiments of the present disclosure, the image selecting interface includes an image selecting region 401, an image previewing region 402, and an interface jumping control 403. The image selecting region 401 is configured to display a plurality of images in a target storage space. FIG. 4 shows that five images are selected and a selection sequence is also shown in each selected images. The image previewing region 402 is configured to allow previewing a selected image, and show the five selected images according the selection sequence in this example. The interface jumping control 403 is configured to jump to another interface and is labeled as “Next”. As illustrated in FIG. 5, which is a schematic diagram of an image editing interface according to some embodiments of the present disclosure, the image editing interface includes an editing previewing region 501 and a plurality of editing function controls, such as a cover editing function control 502. The editing previewing region 501 is configured to allow previewing an image to be edited and the edited image. The cover editing function control 502 is configured to trigger the splicing function and jump to the image splicing interface. Referring to FIG. 4, at least one image displayed in the image selecting region 401 is selected by tapping the at least one image, and the selected image is displayed in the image previewing region 402. Then the image selecting interface illustrated in FIG. 4 is jumped to the image editing interface illustrated in FIG. 5 by tapping the interface jumping control 403. The editing previewing region 501 in the image editing interface is configured to display the image selected in the image selecting region 401. The cover editing function of the short video application is triggered by tapping the cover editing function control 502, and the image editing interface illustrated in FIG. 5 is jumped to the image splicing interface illustrated in the left image of FIG. 6.

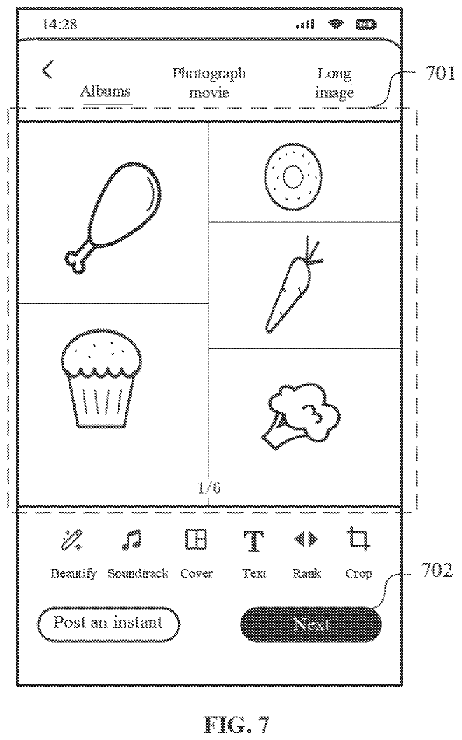

An operation flow of performing the image splicing in the image splicing interface is described hereinafter. As illustrated in FIG. 6, which is a schematic diagram of an image splicing interface according to some embodiments of the present disclosure, the image splicing interface includes a spliced-image previewing region 601, an image selecting region 602, a template selecting region 603, and an editing control 604. As illustrated in the left interface of FIG. 6, the spliced-image previewing region 601 previews the selected images selected by the user in the image selecting interface, the image selecting region 602 displays six images in the target storage space, the template selecting region 603 displays a plurality of groups of splicing templates, and each group of templates includes a splicing template. The target storage space includes the images selected by the user in the image selecting interface and the image stored locally in the electronic device. In the illustrated example, different templates include different numbers of boxes, which correspond to the number of the images to be sliced. As illustrated in the middle interface of FIG. 6, four images in the image selecting region 602 are selected by tapping the four images, which are images to be spliced, and thus the number of images to be spliced is four. The terminal, based on the number of images to be spliced, determines a splicing template that matches the number of images to be spliced to be four as a first splicing template, and selects the first splicing template in the template selecting region 603 (i.e., the template showing four boxes). The terminal displays a spliced-image of the four images to be spliced in the spliced-image previewing region based on the four images to be spliced and this first splicing template. As illustrated in the right interface of FIG. 6, by tapping a splicing template matching five images in the template selecting region (i.e., the template showing five boxes), the terminal determines an image adjacent to the images to be spliced from the target storage space as a newly added image to be spliced, updates the images to be spliced, and displays a spliced image of the five images in the spliced-image previewing region 601 based on the splicing template matching the five images. The image splicing interface illustrated in FIG. 6 is jumped to the image editing interface illustrated in FIG. 7 by tapping the editing control 604, and the spliced image is further edited.

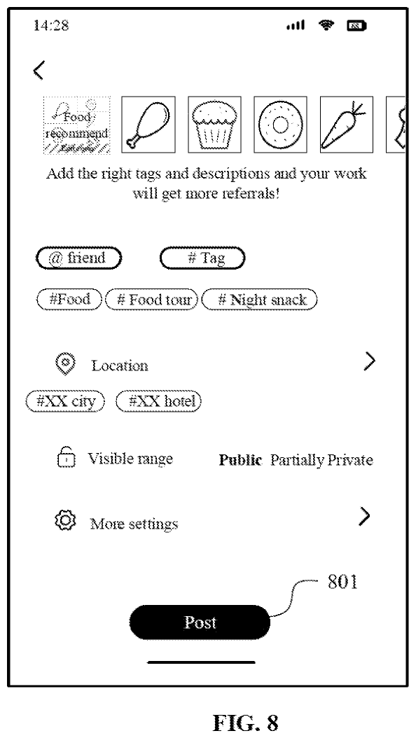

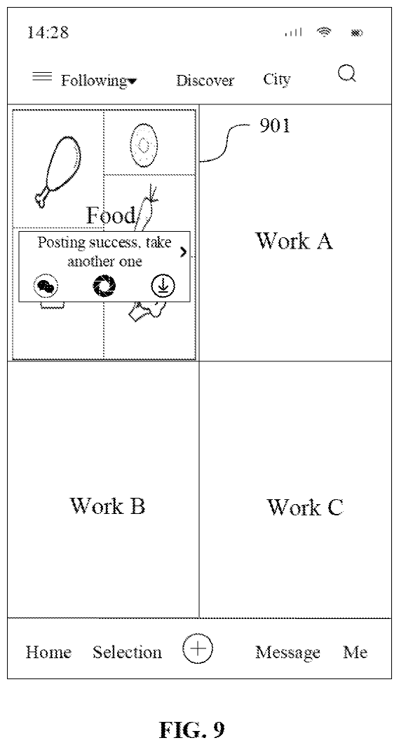

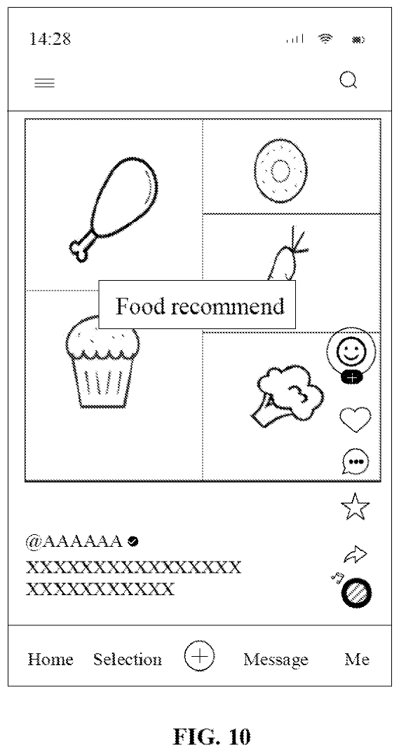

An operation flow of editing the spliced image after the splicing is completed, using the edited spliced image as a cover of a work, and posting the work with the cover of a spliced image is described hereinafter. As illustrated in FIG. 7, which is a schematic diagram of an image editing interface according to some embodiments of the present disclosure, the image editing interface illustrated in FIG. 7 is the same as the image editing interface illustrated in FIG. 5, which is not repeated herein. By tapping the editing control 604, the terminal displays the image editing interface, and the spliced image is displayed in an editing previewing region 701 in the image editing interface. The spliced image is edited by editing function controls, such as “Text” and “Crop” located on the bottom portion of the image editing interface in this example such that the text can be added to the sliced image and the sliced image can be cropped. By tapping an interface jumping control 702, the image editing interface illustrated in FIG. 7 is jumped to a work posting interface illustrated in FIG. 8. As illustrated in FIG. 8, which is a schematic diagram of a work posting interface according to some embodiments of the present disclosure, in the work posting interface, the spliced image is posted as a cover together with the images selected in the image selecting interface by tapping a posting control 801. As illustrated in FIG. 9, which is a schematic diagram of a posting history interface according to some embodiments of the present disclosure, a successfully posted work 901 with a spliced-image cover is displayed in the posting history interface. As illustrated in FIG. 10, which is a schematic diagram of a work playback interface according to some embodiments of the present disclosure, a playback of the work with the spliced-image cover is performed in the work playback interface.

According to the methods described above, images are selected from the image selecting region in the image splicing interface, and thus the user does not need to perform operations such as jumping back and forth in the case that the number of images to be spliced needs to be changed. Moreover, the user replaces the image already existent at the target position of the spliced image by performing the drag operation on the image in the image selecting region, which flexibly adapts to the user's splicing demand and reduces the user's operation cost. Further, the images to be spliced are automatically updated based on the splicing template selected by the user, and the spliced image is displayed in the spliced-image previewing region based on the updated images to be spliced, such that the select operations of the user on the images are reduced, and thus the efficiency in splicing images is improved.

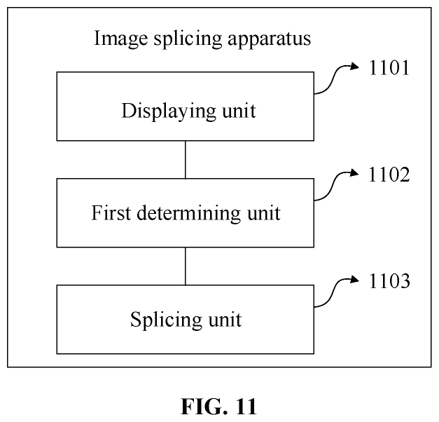

FIG. 11 is a structural block diagram of an image splicing apparatus according to some embodiments of the present disclosure. As illustrated in FIG. 11, the apparatus includes a displaying unit 1101, a first determining unit 1102, and a splicing unit 1103.

The displaying unit 1101 is configured to display an image splicing interface. The image splicing interface includes a spliced-image previewing region, an image selecting region, and a template selecting region. The spliced-image previewing region is configured to allow previewing a spliced image, the image selecting region is configured to display a plurality of images in a target storage space, and the template selecting region is configured to display a plurality of groups of splicing templates. Each group of splicing templates corresponds to a different number of images, and each group of splicing templates includes at least one splicing template.

The first determining unit 1102 is configured to determine an image to be spliced in response to a select operation on at least one image in the image selecting region.

The splicing unit 1103 is configured to display a first spliced image in the spliced-image previewing region based on the image to be spliced and the first splicing template. The first splicing template is a splicing template, matching a first number, in the plurality of groups of splicing templates, and the first number is the number of images to be spliced.

In some embodiments, the apparatus further includes a switching unit, configured to switch images displayed in the image selecting region in response to a swipe operation on the image selecting region.

In some embodiments, the apparatus further includes a replacing unit, configured to, in response to a drag operation on any of the images in the image selecting region, replace an image already existent at a target position of the first spliced image with an image corresponding to the drag operation, in the case that an end point of the drag operation is within the first spliced image.

In some embodiments, the apparatus further includes a second determining unit, configured to determine a second number in response to a tap operation on a second splicing template, and determine a target number based on the first number and the second number, wherein the second number is the number of images matching the second splicing template, and the target number is a difference between the first number and the second number; a first updating unit, configured to, in the case that the first number is greater than or equal to the second number, acquire updated images to be spliced by determining the target number of first images from the images to be spliced and deleting the target number of first images from the images to be spliced; and a second updating unit, configured to, in the case that the first number is less than the second number, acquire updated images to be spliced by determining the target number of second images from the target storage space and adding the target number of second images to the images to be spliced; wherein the splicing unit 1103 is further configured to display a second spliced image in the spliced-image previewing region based on the updated images to be spliced and the second splicing template.

In some embodiments, the first updating unit is further configured to determine, based on selection sequence numbers corresponding to the images to be spliced, top n first images as the target number of first images, n being equal to the target number.

In some embodiments, the second updating unit is configured to perform at least one of: determining, based on a sequence of the images to be spliced in the target storage space, the target number of images adjacent to the images to be spliced as the second images; determining, based on an image attribute condition, the target number of second images from the target storage space, wherein the image attribute condition refers to the second images having a target image attribute; and determining, based on an image date condition, the target number of second images from the target storage space, wherein the image date condition refers to image dates of the second images being within a target period.

In some embodiments, the displaying unit 1101 is further configured to display an image selecting interface, wherein the image selecting interface is configured to display a plurality of images in the target storage; and display an image editing interface in response to a select operation on at least one image in the image selecting interface; wherein displaying the image splicing interface includes: displaying the image splicing interface in response to a splicing function of the image editing interface being triggered.

In some embodiments, the displaying unit 1101 is further configured to display an application function interface, wherein the application function interface includes a splicing function control; and display the image selecting interface in response to a tap operation on the splicing function control; wherein displaying the image splicing interface includes: displaying the image splicing interface in response to a select operation on at least one image in the image selecting interface.

According to the image splicing apparatus described above, images are selected from the image selecting region in the image splicing interface, and thus the user does not need to perform operations such as jumping back and forth in the case that the number of images to be spliced needed to be changed. Moreover, the user replaces the image already existent at the target position of the spliced image by performing the drag operation on the image in the image selecting region, which flexibly adapts to the user's splicing demand and reduces the user's operation cost. Further, the images to be spliced are updated based on the splicing template selected by the user, and the spliced image is displayed in the spliced-image previewing region based on the updated images to be spliced, such that the select operations of the user on the images are reduced, and thus the efficiency in splicing images is improved.

It should be noted that description is only given to the division of the functional modules for the image splicing apparatus according to the above embodiments when performing corresponding steps. In practice, the functions of the apparatus may be assigned to and implemented by different functional modules according to actual needs. That is, in terms of internal structure, the apparatus is divided into different functional modules to implement a part or all of the functions as described above. In addition, the image splicing apparatus according to the above embodiments is based on the same concept as the image splicing method embodiments as described above, and the specific implementation process of the apparatus is detailed in the method embodiments, which is not repeated herein.

In some embodiments, an electronic device is provided. The electronic device includes a processor and a memory. The memory stores at least one computer program therein. The at least one computer program, when loaded and executed by the processor of the electronic device, causes the electronic device to perform the image splicing method described above.

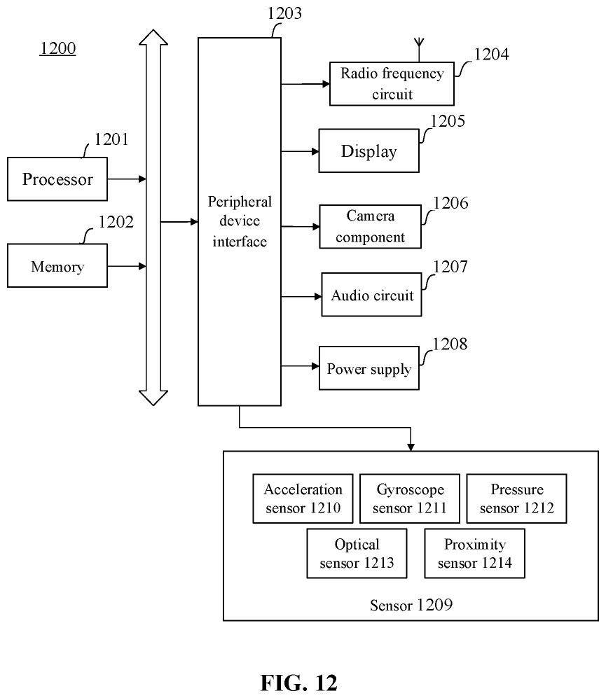

The description is given using a scenario where the electronic device is the terminal as an example. FIG. 12 is a structural block diagram of a terminal according to some embodiments of the present disclosure. As illustrated in FIG. 12, the terminal 1200 is a smartphone, a tablet computer, a moving image experts group audio layer III (MP3) player, a moving image experts group audio layer IV (MP4) player, or a laptop or desktop computer. The terminal 1200 is also referred to as a user device, a portable terminal, a laptop terminal, a desktop terminal, and other names.

Typically, the terminal 1200 includes a processor 1201 and a memory 1202.

The processor 1201 includes one or more processing cores, such as a 4-core processor or an 8-core processor. The processor 1201 is implemented using a hardware form of at least one of a digital signal processor (DSP), a field-programmable gate array (FPGA), and a programmable logic array (PLA). The processor 1201 also includes a main processor and a co-processor. The main processor is a processor, also referred to as a central processing unit (CPU), for processing data in a wake-up state; and the co-processor is a low-power processor for processing data in a standby state. In some embodiments, the processor 1201 is integrated with a graphics processing unit (GPU). The GPU is used to render and draw the content to be displayed by the display. In some embodiments, the processor 1201 also includes an Artificial Intelligence (AI) processor that is used to handle computational operations related to machine learning.

The memory 1202 includes one or more computer-readable storage media, which in some embodiments are non-transitory. In some embodiments, the memory 1202 further includes a high-speed random access memory and a non-volatile memory, such as one or more disk storage devices and flash memory storage devices. In some embodiments, the non-transitory computer-readable storage medium in the memory 1202 is configured to store at least one program code. The at least one program code, when loaded and executed by the processor 1201 of the terminal 1200, causes the terminal 1200 to perform the image splicing method according to the method embodiments of the present disclosure.

In some embodiments, the terminal 1200 further optionally includes a peripheral device interface 1203 and at least one peripheral device. The processor 1201, the memory 1202, and the peripheral device interface 1203 are connected to each other by a bus or signal lines. Each peripheral device is connected to the peripheral device interface 1203 by a bus, a signal line, or a circuit board. Schematically, the peripheral devices include at least one of a radio frequency circuit 1204, a display 1205, a camera component 1206, an audio circuit 1207, and a power supply 1208.

The peripheral device interface 1203 is configured to connect at least one peripheral device related to an input/output (I/O) to the processor 1201 and the memory 1202. In some embodiments, the processor 1201, the memory 1202, and the peripheral device interface 1203 are integrated into the same chip or board, and in some other embodiments, either or both of the processor 1201, the memory 1202, and the peripheral device interface 1203 may be implemented on a separate chip or board, which are not limited herein.

The radio frequency circuit 1204 is configured to receive and transmit radio frequency (RF) signals, also known as electromagnetic signals. The radio frequency circuit 1204 communicates with communication networks and other communication devices over the electromagnetic signals. The radio frequency circuit 1204 converts electrical signals to electromagnetic signals for transmission, or converts received electromagnetic signals to electrical signals. In some embodiments, the radio frequency circuit 1204 includes an antenna system, a radio frequency transceiver, one or more amplifiers, a tuner, an oscillator, a digital signal processor, a codec chipset, a user identity module card, and the like. The radio frequency circuit 1204 communicates with other terminals by at least one wireless communication protocol. The wireless communication protocols include, but are not limited to metropolitan area networks, various generations of mobile communication networks (2G, 3G, 4G, and 5G), wireless local area networks, and/or wireless fidelity (Wi-Fi) networks. In some embodiments, the radio frequency circuit 1204 further includes a near field communication (NFC) related circuit, which is not limited herein.

The display 1205 is configured to display a user interface (UI). The UI includes graphics, text, icons, video, and any combination thereof. In the case that the display 1205 is a touch display, the display 1205 further has the ability to capture a touch signal at or above a surface of the display 1205. This touch signal is input to the processor 1201 as a control signal for processing. At this point, the display 1205 is further configured to provide a virtual button and/or a virtual keyboard, also referred to as a soft button and/or a soft keyboard. In some embodiments, the display 1205 is a front panel arranged on the terminal 1200; in other embodiments, there are at least two displays 1205, arranged on different surfaces of the terminal 1200 or in a folded design; and in other embodiments, the display 1205 is a flexible display, arranged on a curved surface or a folded surface of the terminal 1200. Even more, the display 1205 is arranged in a non-rectangular irregular shape, i.e., a shaped screen. The display screen 1205 is prepared using materials such as a liquid crystal display (LCD), an organic light-emitting diode (OLED), and the like.

The camera component 1206 is configured to capture images or videos. In some embodiments, the camera component 1206 includes a front camera and a rear camera. Typically, the front camera is arranged on the front panel of the terminal and the rear camera is arranged on the back of the terminal. In some embodiments, there are at least two rear cameras, each of which is any one of a main camera, a depth-of-field camera, a wide-angle camera, and a telephoto camera, to achieve a background defocusing function by the fusion of the main camera and the depth-of-field camera, a panoramic or virtual reality (VR) shooting function by the fusion of the main camera and the wide-angle camera, or other fusion shooting functions. In some embodiments, the camera component 1206 further includes a flash. The flash is a single-color temperature flash or a dual-color temperature flash. The dual color temperature flash is a combination of a warm light flash and a cool light flash and is configured for light compensation at different color temperatures.

The audio circuit 1207 includes a microphone and a loudspeaker. The microphone is configured to capture sound waves from a user and an environment, convert the sound waves into electrical signals, and input the electrical signals to the processor 1201 for processing or to the radio frequency circuit 1204 for voice communication. For the purpose of stereo sound recording or noise reduction, there are a plurality of microphones, which are arranged at different parts of the terminal 1200. In some embodiments, the microphones are array microphones or omnidirectional capture type microphones. The loudspeaker is configured to convert the electrical signals from the processor 1201 or the radio frequency circuit 1204 into sound waves. The loudspeaker is a conventional thin film loudspeaker or a piezoelectric ceramic loudspeaker. In the case that the loudspeaker is the piezoelectric ceramic loudspeaker, it is possible to convert the electrical signals to sound waves that are audible to humans and convert the electrical signals to sound waves that are inaudible to humans for purposes of ranging. In some embodiments, the audio circuit 1207 further includes a headphone jack.

The power supply 1208 is configured to power various components in the terminal 1200. The power supply 1208 is an alternating current, a direct current, a disposable battery, or a rechargeable battery. Where the power supply 1208 includes the rechargeable battery, the rechargeable battery supports wired charging or wireless charging. The rechargeable battery further supports the fast charging technology.

In some embodiments, the terminal 1200 further includes one or more sensors 1209. The one or more sensors 1209 include, but are not limited to an acceleration sensor 1210, a gyroscope sensor 1211, a pressure sensor 1212, an optical sensor 1213, and a proximity sensor 1214.

The acceleration sensor 1210 detects the magnitude of acceleration on three coordinate axes of a coordinate system established by the terminal 1200. For example, the acceleration sensor 1210 is configured to detect components of acceleration of gravity on the three coordinate axes. The processor 1201 controls the display 1205 to display the user interface in a horizontal view or a longitudinal view based on gravitational acceleration signals collected by the acceleration sensor 1210. The acceleration sensor 1210 is further configured to collect motion data of games or users.

The gyroscope sensor 1211 detects a body direction and rotation angle of the terminal 1200. The gyroscope sensor 1211 collects 3D motions by the user to the terminal 1200 collaborating with the acceleration sensor 1210. The processor 1201, based on the data collected by the gyroscope sensor 1211, implements the following functions: motion sensing (e.g., changing the UI based on the user's tilt operation), image stabilization during shooting, game control, and inertial navigation.

The pressure sensor 1212 is arranged on a side bezel of the terminal 1200 and/or a lower layer of the display 1205. In the case that the pressure sensor 1212 is arranged on the side bezel of the terminal 1200, a grip signal from a user to the terminal 1200 is detected, and the processor 1201 performs a recognition of right and left hands or a shortcut operation based on the grip signal collected by the pressure sensor 1212. In the case that the pressure sensor 1212 is arranged in the lower layer of the display 1205, the processor 1201 controls an operable control on the UI page according to a pressure operation of the user on the display 1205. The operable control includes at least one of a button control, a scroll bar control, an icon control, and a menu control.

The optical sensor 1213 is configured to capture ambient light intensity. In some embodiments, the processor 1201 controls the display brightness of the display 1205 based on the ambient light intensity captured by the optical sensor 1213. Schematically, the display brightness of the display 1205 is turned up in case of high ambient light intensity, and the display brightness of the display 1205 is turned down in case of low ambient light intensity. In some other embodiments, the processor 1201 dynamically adjusts shooting parameters of the camera component 1206 based on the ambient light intensity captured by the optical sensor 1213.

The proximity sensor 1214, also referred to as a distance sensor, is typically arranged on the front panel of the terminal 1200. The proximity sensor 1214 is configured to capture a distance between a user and the front of the terminal 1200. In some embodiments, in the case that the proximity sensor 1214 detects that the distance between the user and the front of the terminal 1200 gradually becomes smaller, the display 1205 is controlled by the processor 1201 to switch from a bright screen state to a lock screen state; and in the case that the proximity sensor 1214 detects that the distance between the user and the front of the terminal 1200 gradually becomes larger, the processor 1201 controls the display 1205 to switch from the lock screen state to the bright screen state.

It should be understood by those skilled in the art that the structure illustrated in FIG. 12 does not constitute any limitation to the terminal 1200, and in some embodiments, the terminal 1200 includes more or fewer components than illustrated or a combination thereof, or employs different arrangements of components.

According to some embodiments of the present disclosure, a non-transitory computer-readable storage medium including one or more program codes, such as the memory 1202 including one or more program codes, is provided. The one or more program codes, when loaded and executed by the processor 1201 of the terminal 1200, cause the terminal to perform the image splicing method described above. In some embodiments, the non-transitory computer-readable storage medium is a read-only memory (ROM), a random access memory (RAM), a compact-disc read-only memory (CD-ROM), a magnetic tape, a floppy disk, or an optical data storage device.

According to some embodiments of the present disclosure, a computer program product including one or more instructions is further provided. The one or more instructions, when loaded and executed by one or more processors of an electronic device, cause the electronic device to perform the image splicing method described above.

All embodiments of the present disclosure are performed alone or in combination with other embodiments, which are considered to be within the scope of protection claimed herein.

What is claimed is:

1. An image splicing method, performed by an electronic device, comprising:
displaying an image splicing interface, the image splicing interface comprising a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates comprising at least one splicing template;
determining an image to be spliced in response to a select operation on at least one of the images in the image selecting region; and
displaying a first spliced image in the spliced-image previewing region based on the image to be spliced and a first splicing template, wherein the first splicing template is a splicing template that matches a first number in the plurality of groups of splicing templates, and the first number is a number of the images to be spliced.

2. The image splicing method according to claim 1, further comprising:
switching the images displayed in the image selecting region in response to a swipe operation on the image selecting region to display different images for selection.

3. The image splicing method according to claim 1, further comprising:
in response to a drag operation on any of the images in the image selecting region, replacing an image already existent at a target position of the first spliced image with an image corresponding to the drag operation in a case that an end point of the drag operation is within the first spliced image.

4. The image splicing method according to claim 1, further comprising:
determining a second number in response to a tap operation on a second splicing template, and determining a target number based on the first number and the second number, wherein the second number is a number of images matching a number of images in the second splicing template, and the target number is a difference between the first number and the second number; and
in a case that the first number is greater than or equal to the second number, acquiring updated images to be spliced by determining a target number of images from the first images to be spliced and deleting the target number of images from the first images to be spliced; or
in a case that the first number is less than the second number, acquiring updated images to be spliced by determining a target number of images from the target storage space and adding the target number of images to the images to be spliced.

5. The image splicing method according to claim 4, wherein said acquiring updated images to be spliced by determining the target number of images from the first images to be spliced and deleting the target number of images from the images to be spliced comprises:
determining, based on selection sequence numbers corresponding to the images to be spliced, a first n images that appears in a selection sequence of the first images as the target number of images, wherein n is equal to the target number.

6. The image splicing method according to claim 4, wherein said acquiring updated images to be spliced by determining the target number of images from the target storage space and adding the target number of images to the images to be sliced comprises at least one of:
determining, based on a sequence of the images to be spliced in the target storage space, the target number of images adjacent to the images to be spliced as the second images to be added;
determining, based on an image attribute condition, the target number of images to be added from the target storage space, wherein the image attribute condition refers to the second images having a target image attribute; or
determining, based on an image date condition, the target number of images to be added from the target storage space, wherein the image date condition refers to image dates of the second images within a target period.

7. The image splicing method according to claim 1, further comprising:
displaying an image selecting interface, wherein the image selecting interface is configured to display the plurality of images in the target storage space; and
displaying an image editing interface in response to a select operation on at least one of the images in the image selecting interface;
wherein said displaying the image splicing interface comprises:
displaying the image splicing interface in response to a splicing function in the image editing interface being triggered.

8. The image splicing method according to claim 1, further comprising:
displaying an application function interface, wherein the application function interface comprises a splicing function control; and
displaying an image selecting interface in response to a tap operation on the splicing function control;
wherein said displaying the image splicing interface comprises:
displaying the image splicing interface in response to a select operation on at least one image in the image selecting interface.

9. The image splicing method according to claim 1, wherein in a case that each group of splicing templates comprises a plurality of splicing templates, said determining the first splicing template comprises:
determining a third splicing template in each group of splicing templates based on a history splicing process of a user, wherein the third splicing template in each group of splicing templates is a splicing template whose use frequency is ranked at a top place, and determining a splicing template whose number of images matches the first number in the third splicing templates as the first splicing template; or
determining a fourth splicing template in each group of splicing templates based on usage of the splicing templates by all users, wherein the fourth splicing template in each group of splicing templates is a splicing template whose number of users is ranked at a top place, and determining a splicing template whose number of images matches the first number in the fourth splicing templates as the first splicing template.

10. An electronic device, comprising
one or more processors; and
a memory, configured to store one or more program codes executable by the one or more processors;
wherein the one or more processors, when loading and executing the one or more program codes, are caused to perform:
displaying an image splicing interface, the image splicing interface comprising a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates comprising at least one splicing template;
determining an image to be spliced in response to a select operation on at least one of the images in the image selecting region; and
displaying a first spliced image in the spliced-image previewing region based on the image to be spliced and a first splicing template, wherein the first splicing template is a splicing template that matches a first number in the plurality of groups of splicing templates, the first number being a number of the images to be spliced.

11. The electronic device according to claim 10, wherein the one or more processors, when loading and executing the one or more program codes, are further caused to perform:
switching the images displayed in the image selecting region in response to a swipe operation on the image selecting region.

12. The electronic device according to claim 10, wherein the one or more processors, when loading and executing the one or more program codes, are further caused to perform:
in response to a drag operation on any of the images in the image selecting region, replacing an image already existent at any position of the first spliced image with an image corresponding to the drag operation, in a case that an end point of the drag operation is within the first spliced image.

13. The electronic device according to claim 10, wherein the one or more processors, when loading and executing the one or more program codes, are further caused to perform:
determining a second number in response to a tap operation on a second splicing template, and determining a target number based on the first number and the second number, wherein the second number is a number of images matching a number of second images in the second splicing template, and the target number is a difference between the first number and the second number; and
in a case that the first number is greater than or equal to the second number, acquiring updated images to be spliced by determining a target number of images from the first images to be spliced and deleting the target number of images from the first images to be spliced; or
in a case that the first number is less than the second number, acquiring updated images to be spliced by determining a target number of image from the target storage space and adding the target number of images to the images to be spliced; and
displaying a second spliced image based on the updated images to be spliced and the second splicing template.

14. The electronic device according to claim 13, wherein the one or more processors, when loading and executing the one or more program codes, are further caused to perform:
in a case that the first number is greater than or equal to the second number, determining, based on selection sequence numbers corresponding to the images to be spliced, a first n images that appears in a selection sequence of the first images as the target number of images, wherein n is equal to the target number.

15. The electronic device according to claim 13, wherein the one or more processors, when loading and executing the one or more program codes, are further caused to perform at least one of:
in a case that the first number is less than the second number, determining, based on a sequence of the images to be spliced in the target storage space, the target number of images adjacent to the images to be spliced as the second images to be added;
determining, based on an image attribute condition, the target number of images to be added from the target storage space, wherein the image attribute condition refers to the second images having a target image attribute; or
determining, based on an image date condition, the target number of images to be added from the target storage space, wherein the image date condition refers to image dates of the second images within a target period.

16. The electronic device according to claim 10, wherein the one or more processors, when loading and executing the one or more program codes, are further caused to perform:
displaying an image selecting interface, wherein the image selecting interface is configured to display the plurality of images in the target storage space; and
displaying an image editing interface in response to a select operation on at least one of the images in the image selecting interface;
wherein said displaying the image splicing interface comprises:
displaying the image splicing interface in response to a splicing function in the image editing interface being triggered.

17. The electronic device according to claim 10, wherein the one or more processors, when loading and executing the one or more program codes, are further caused to perform:
displaying an application function interface, wherein the application function interface comprises a splicing function control; and
displaying an image selecting interface in response to a tap operation on the splicing function control;
wherein said displaying the image splicing interface comprises:
displaying the image splicing interface in response to a select operation on at least one image in the image selecting interface.

18. The electronic device according to claim 10, wherein the one or more processors, when loading and executing the one or more program codes, are further caused to perform:
determining a third splicing template in each group of splicing templates based on a history splicing process of a user, wherein the third splicing template in each group of splicing templates is a splicing template whose use frequency is ranked at a top place, and determining a splicing template whose number of images matches the first number in the third splicing templates as the first splicing template; or
determining a fourth splicing template in each group of splicing templates based on usage of the splicing templates by all users, wherein the fourth splicing template in each group of splicing templates is a splicing template whose number of users is ranked at a top place, and determining a splicing template whose number of images matches the first number in the fourth splicing templates as the first splicing template.

19. A non-transitory computer-readable storage medium storing one or more program codes, wherein the one or more program codes, when loaded and executed by a processor of an electronic device, cause the electronic device to perform:
displaying an image splicing interface, the image splicing interface comprising a spliced-image previewing region, an image selecting region, and a template selecting region, wherein the spliced-image previewing region is configured to allow previewing a spliced image, the image selecting region is configured to display a plurality of images in a target storage space, and the template selecting region is configured to display a plurality of groups of splicing templates, each group of splicing templates corresponding to a different number of images, and each group of splicing templates comprising at least one splicing template;
determining an image to be spliced in response to a select operation on at least one of the images in the image selecting region; and
displaying a first spliced image in the spliced-image previewing region based on the image to be spliced and a first splicing template, wherein the first splicing template is a splicing template, matching a first number, in the plurality of groups of splicing templates, the first number being a number of the images to be spliced.
